(19) United States
(12) Patent Application Publication
(10) Pub. No.: US 2020/0374422 A1
(43) Pub. Date: Nov. 26, 2020

(54) SYSTEM AND METHOD OF SYNCHRONIZING VIDEO AND AUDIO CLIPS WITH AUDIO DATA

(71) Applicant: GRASS VALLEY CANADA, Montreal (CA)

(72) Inventors: Yousuke TAKADA, Kobe (JP); Kenrou AWASHIMA, Kobe (JP); Yasunori NII, Kobe (JP); Yoshinobu ISHIMOTO, Kobe (JP)

(21) Appl. No.: 16/878,356

(22) Filed: May 19, 2020

Related U.S. Application Data
(60) Provisional application No. 62/852,649, filed on May 24, 2019.

(51) Int. Cl. H04N 5/06; H04N 5/262; G10L 25/18; G10L 25/51; H04N 5/76

(52) U.S. Cl. CPC H04N 5/06; H04N 5/262; H04N 5/76; G10L 25/51; G10L 25/18

(57) ABSTRACT

A system is provided for synchronizing video clips with audio data. The system includes one or more video capture devices that captures audio and video data of a scene, and a data store for the audio data, the metadata, and the video data generated by each respective capture device. Moreover, the system includes an audio analyzer that analyzes the audio data to determine one or more groups of overlapping video clips in the video data and to generate offset information for each video clip in the one or more groups. A metadata analyzer then corrects the one or more groups of the overlapping video clips based on camera identification data, and a sequence generator generates a plurality of video sequences with synchronized audio, based on the corrected one or more groups.

### CROSS REFERENCE TO RELATED APPLICATIONS

The present application claims priority to U.S. Patent Provisional Application No. 62/852,649, filed May 24, 2019, the entire contents of which are hereby incorporated by reference.

### TECHNICAL FIELD

The present disclosure generally relates to video editing and production, and, more particularly, to a system and method of synchronizing video and audio clips with audio data.

### BACKGROUND

The technology of synchronizing video clips with audio data exists today and is available in video editing software. However, users need to select proper video clips before applying the technologies currently available. Therefore, if video clips in multiple scenes are combined in the selection, current technology does not work properly. Moreover, editing with scenes captured by multiple cameras requires significant production time, especially when large number of video clips were shot unorganized with non-broadcasting grade cameras which do not have the timecode feature.

For example, when using broadcasting grade camcorders, the free run time-code feature is standard and is often used to synchronize multiple clips. However, certain users capturing content may use action-type cameras (e.g., GoPRO® or the like), which generally do not have a free run timecode feature. In this case, customers may have difficulties in synchronizing clips using audio.

Thus, while some existing products feature synchronization techniques using audio information, these techniques are limited in scope and are not particularly efficient and user/resource friendly.

### SUMMARY

Thus, according to an exemplary aspect, systems and methods are disclosed that are configured to synchronize video clips with audio data. According to the exemplary aspects described herein, users do not need pre-selection of video clips. Instead, if selected clips were shot in multiple scenes, multiple video sequences would be generated automatically.

In general, the system comprises one or more video capture devices configured to capture video and audio data related to the scene, a data store configured to store the audio, the metadata, and the video data generated by each respective capture device, an audio synchronization module configured to: receive video and audio data, compare timecode data in the video data to metadata in the audio data, and generate a plurality of video sequences with synchronized audio, based on the timecode information.

According to an exemplary aspect, a system is provided for synchronizing video clips with audio data. In this aspect, the system includes a plurality of more video capture devices configured to capture audio and video data of a scene and to generate timecode data for the video data respectively; a data store configured to store the audio and video data generated by each respective capture device and metadata that includes the generated timecode data and camera identification data; an audio analyzer configured to analyze the audio data to determine a group of overlapping video clips in the video data based on a common characteristic point for the audio data associated with the group of overlapping video clips, and further configured to generate offset information for each video clip in the group that represents respective time durations that each video clip in the group of overlapping video clips is time offset from the characteristic point; a metadata analyzer configured to correct the group of the overlapping video clips based on the generated timecode data and the camera identification data for the respective capture devices; and a sequence generator configured to generate a plurality of video sequences with synchronized audio for the group of the overlapping video clips, wherein the plurality of video sequences are generated as a video editing file configured for editing by a video software editing application.

In a refinement of the exemplary aspect, the camera identification data comprises a reel name and serial information for each respective video capture device.

In another refinement of the exemplary aspect, the audio analyzer is further configured to determine the group of overlapping video clips by comparing audio signals associated with the plurality of video capture devices to identify the common characteristic point. Moreover, the audio analyzer can be further configured compare the audio signals based on a frequency spectrum analysis or volume comparison of the respective audio data captured by the plurality of video capture devices.

In another refinement of the exemplary aspect, the group of overlapping video clips in the video data is a subset of the video data based on the time offset being within a predefined time duration of the characteristic point.

In yet another exemplary aspect, a system is provided for synchronizing video clips with audio data. In this aspect, the system includes at least one video capture device configured to capture video data of a scene and to generate timecode data for the video data; a data store configured to store video data generated by each respective capture device, audio for the video data, and metadata that includes the generated timecode data; an audio analyzer configured to analyze the audio data to determine a group of overlapping video clips in the video data based on a characteristic point for the audio data associated with the group of overlapping video clips, and further configured to generate offset information for each video clip in the group that represents respective time durations that each video clip in the group of overlapping video clips is time offset from the characteristic point; a metadata analyzer configured to correct the group of the overlapping video clips based on the generated timecode data of the video data and the generated offset information for each video clip; and a sequence generator configured to generate a plurality of video sequences with synchronized audio for the group of the overlapping video clips.

In yet another exemplary aspect, a system is provided for synchronizing video clips with audio data. In this aspect, the system includes a video capture device configured to capture video data of a scene and to generate timecode data for the video data; an audio analyzer configured to analyze audio data associated with the video data to determine a group of overlapping video clips in the video data based on a characteristic point for the audio data associated with the group of overlapping video clips, and further configured to generate offset information for each video clip in the group; a metadata analyzer configured to correct the group of the overlapping video clips based on the generated timecode data of the video data and the generated offset information for each video clip; and a sequence generator configured to generate a plurality of video sequences with synchronized audio from the audio data for the group of the overlapping video clips, wherein the plurality of video sequences are generated as part of a video editing file configured for editing by a video software editing application.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplary pointed out in the claims.

### BRIEF DESCRIPTION OF THE DRAWINGS

FIG. 1 is a block diagram of a system of synchronizing video clips with audio data, in accordance with exemplary aspects of the present disclosure.

FIG. 2 is a block diagram illustrating components of video data, according to exemplary aspects of the disclosure.

FIG. 3 is a block diagram illustrating components of audio data, according to exemplary aspects of the disclosure.

FIG. 4 is a block diagram illustrating the audio synchronization engine in further detail, according to exemplary aspects of the disclosure.

FIG. 5 is a flow diagram of a method of synchronizing video clips with audio data, in accordance with exemplary aspects of the present disclosure.

FIG. 6 is a block diagram illustrating a computer system on which aspects of systems and methods of identifying equivalents for task completion may be implemented in accordance with an exemplary aspect.

### DETAILED DESCRIPTION

Various aspects of the disclosure are now described with reference to the drawings, wherein like reference numerals are used to refer to like elements throughout. In the following description, for purposes of explanation, numerous specific details are set forth in order to promote a thorough understanding of one or more aspects of the disclosure. It may be evident in some or all instances, however, that any aspects described below can be practiced without adopting the specific design details described below. In other instances, well-known structures and devices are shown in block diagram form in order to facilitate description of one or more aspects. The following presents a simplified summary of one or more aspects of the disclosure in order to provide a basic understanding thereof.

The limitations of current technology is the assumption that all of the clips captured by a particular camera are shot in close timing to each other. However, if clips selected, for example in video editing software, are shot at separate times, current technology cannot synchronize the audio between these clips appropriately. For example when selecting eight clips for video/audio synchronization, three of these clips are shot almost at the same time at, for example, 10:00 AM, and five of these clips are shot at the same time around 11:00 PM. With aspects of the current disclosure, the three clips are identified as a group and one sequence will be generated. The remaining five clips are identified as a separate group and another sequence will be generated for these clips.

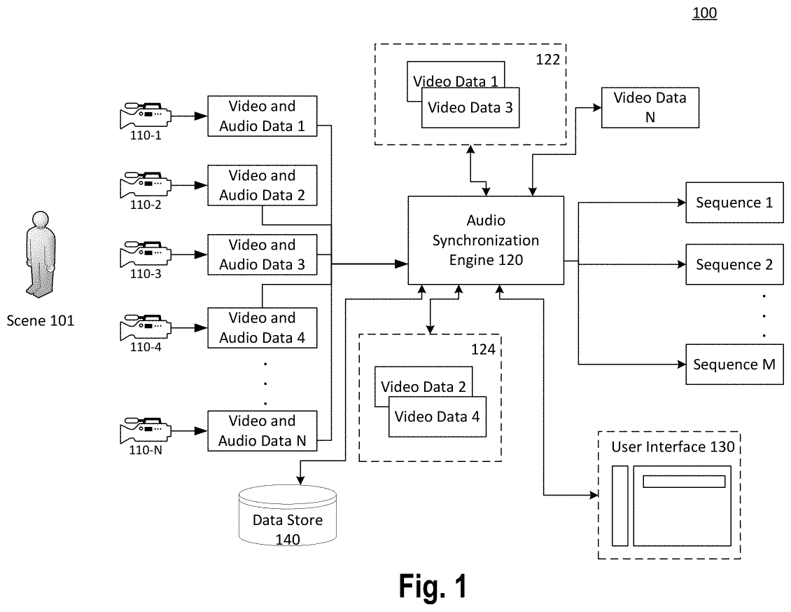

FIG. 1 is a block diagram of a system 100 for synchronizing video clips with audio data, in accordance with exemplary aspects of the present disclosure. As shown, the system 100 comprises a plurality of video capture devices (e.g., cameras) 110-1, 110-2, 110-3, 110-4 to 110-N (collectively referred to as “video capture devices 110”) for capturing video and audio data 1 to N of the scene 101. In exemplary aspects, the video capture devices 110 comprise audio capture capabilities, and they are configured to generate the audio data 104 (e.g., audio clips), though in some aspects additional microphones may be used that are separate and apart from the video capture devices. Moreover, the filming of the scene 101 may be live, while in others the video and audio data 1-N is collected and stored in a video database or server, for example. The system 100 further comprises an audio synchronization engine 120 that is configured to synchronize the audio data and the video data to generate a sequence of video streams 1 to M, which are shown as Sequences 1, 2, . . . M. In an exemplary aspect, these sequences of video clips with synchronized data can be provided to a video editing tool for further editing before production as would be appreciated to one skilled in the art.

In an exemplary aspect, the video capture devices 110-1 to 110-N are standard filming cameras that generate image and audio data related to the scene 101, and also generate timecode data related to the captured content. Each of these cameras generate separate data since they may be recording different perspectives of the scene 101, or entirely different scenes. In some aspects, the video capture devices 110-1 to 110-N are recording the same object at the same time and in some aspects, the cameras 110 take several videos around approximately the same time while one or more video clips are captured at different times. For example, camera 110-1 and camera 110-2 may be filming the same scene of a car driving, while camera 110-1 focuses on the driver and camera 110-2 focuses on the passengers or the like. In some aspects, each camera may generate a camera identification data (e.g., identification metadata), or may allow a camera identification data to be manually entered to identify the video data. The camera identification data may include reel name of the camera and serial information of the camera in exemplary aspects.

The system 100 allows a video editor the ability to synchronize the disparate audio streams and video data to generate one or more coherent sequences of video streams for optimal viewing. The audio synchronization engine 120 receives the video and audio data 1 through N from the plurality of cameras 110-1 to 110-N (i.e., video capture devices). In some aspects, the audio synchronization engine 120 is configured to perform dynamic synchronization as the video and audio data is received, while in other aspects, the audio synchronization engine 120 retrieves the audio and/or video data from a data store 140 sometime after the audio and video data is captured. In some aspects, the data store 140 may be a type of database, while in other aspects the data store 140 may be a file server, or simply physical or cloud data storage.

Subsequently, after the audio synchronization engine 120 retrieves the video and audio data 1-N for the specified time range from the data store 140, the audio synchronization engine 120 is configured to determine which video clips are related and which are unrelated. For example, FIG. 1 shows that two groups of video data are generated: group 122 comprising video data 1 and video data 3, and group 124 comprising video data 2 and video data 4. It may be determined that some videos are not related to any other clips, e.g., video data N. The groups may indicate that the video in the video data was taken at the same time, or within the same time frame, while video data not grouped has no audio matching parts. In other words, the audio synchronization engine 120 can be configured to automatically group the video data based on respective metadata generated by the video capture devices, which indicate the time frame the media content was captured, for example.

According to exemplary aspects, the audio synchronization engine 120 is configured to analyze and inspect an audio signal from the audio data. The audio synchronization engine 120 can then determine which clips from the video data are shot at the same time, in addition to determining overlapping video clips along with offset time values. In an exemplary aspect, the audio synchronization engine 120 is configured to determine this overlap by comparing audio signals associated with each of the cameras and identifying characteristic points. In some exemplary aspects, this comparison is performed using frequency spectrum analysis, volume comparisons and other technologies that aid in determining overlap time in video clips based on the audio data. In some aspects, the engine 120 generates scores to select the highest probability of the clip groups or clusters that were shot at the same time. Accordingly, the audio synchronization engine 120 is configured to create clusters of video clips using this metadata, with each cluster consisting of multiple clips shot at overlapping timings, along with the offset information for each clip based on the characteristic point identified earlier. The audio synchronization engine 120 then inspects timecode data from the video data of the cluster and camera identification data from the camera to improve the accuracy of clusters, e.g., the video groups 122 and 124. For example, by removing one or move video clips from the set cluster if the generated timecode data does not match the video content of an expected camera having the correct camera identification data.

This information is used by the audio synchronization engine 120 to then correct the output of the audio analysis portion, and generate the finished sequences 1 to M. For example, when a set of audio clips have recorded a single song multiple times, it is highly likely that all of the audio clips are in one group, since songs generally repeat lyrics or phrases. If the timecode or other time related information is referenced, the audio synchronization engine 120 may separate the clips into multiple groups. The sequences 1 to M have synchronized audio and video in individual video streams. In some aspects, a single camera, e.g., camera 110-1 produces multiple video clips (e.g., video data) a portion of which occur at a first time, and a portion of which occur at a second time. The audio synchronization engine 120 receives or selects all of the video clips, but groups them into groups according to their time and other data in the video data, and uses the audio data 104 to generate two distinct sequences—one sequence of video for the first time, and one sequence of video for the second time. In an exemplary aspect, the audio synchronization engine 120 is further configured to generate a video editing file that includes the plurality of video sequences that are generated and grouped together, such that the video editing file can be transmitted to a video software editing application (e.g., a third-party editing software or application) for further process before further video production or playout.

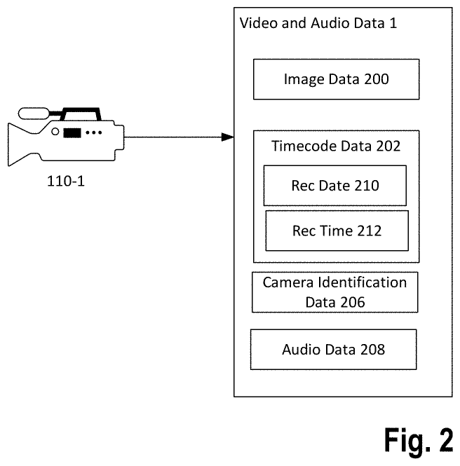

FIG. 2 is a block diagram illustrating components of video data, according to exemplary aspects of the disclosure. It is noted that the video data shown in FIG. 2 corresponds to the captured video described above with respect to FIG. 1. As shown, the video data (e.g., video data 1) comprises image data 200 (e.g., the actual media essence), timecode data 202, camera identification data 206 and audio data 208. In exemplary aspects, the image data 200 contains all of the data captured relating to the visual aspects of the scene 101 such as the various frames of the video, color information, and the like. The timecode data 202 comprises at least recording date 210 and recording time 212 for the video and audio data that provides synchronization information. In some aspects, timecode information is keyed to respective frames of a video sequence within the image data 200 so that precise times are assigned to frames for later synchronization. The camera identification data 206 comprises reel name and/or camera serial information, and the like, and is provided to the audio synchronization engine 120 to distinguish recordings of different scenes, perspectives, color settings or the like.

In exemplary aspects the camera identification data may be automatically generated, and may match other clips generated within a predetermined time period. Alternatively, a user may assign the camera identification data and choose to assign the same identification (ID) to clips that are captured at the same time. In exemplary aspects, the camera identification data provides supporting data to the audio synchronization engine 120 to improve accuracy and correct the clustering of the generated video clips.

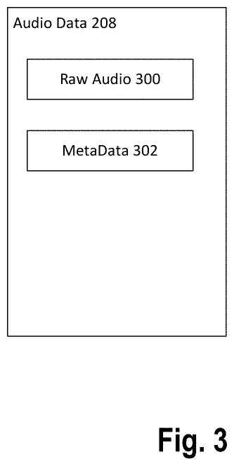

FIG. 3 is a block diagram illustrating components of audio data, according to exemplary aspects of the disclosure. The audio data 208 may comprise the raw audio 300 captured by each camera, and metadata 302. In some aspects the raw audio 300 may be compressed or delivered uncompressed to the audio synchronization engine 120, or stored in the data store 140. The metadata 302 contains time related information that indexes the raw audio 300 with respective times that the audio data was captured to aid in synchronization by the audio synchronization engine 120 with the video data

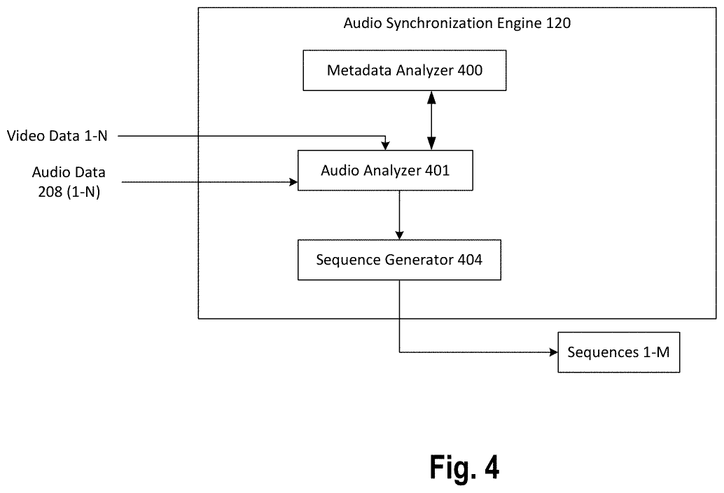

FIG. 4 is a block diagram illustrating the audio synchronization engine 120 in further detail, according to exemplary aspects of the disclosure. In an exemplary aspect, each component of the audio synchronization engine 120 can be implemented as one or more modules configured to perform the algorithms described herein. Moreover, the term “module” refers to a real-world device, component, or arrangement of components implemented using hardware, such as by an application specific integrated circuit (ASIC) or field-programmable gate array (FPGA), for example, or as a combination of hardware and software, such as by a microprocessor system and a set of instructions to implement the module's functionality, which (while being executed) transform the microprocessor system into a special-purpose device. A module can also be implemented as a combination of the two, with certain functions facilitated by hardware alone, and other functions facilitated by a combination of hardware and software. In certain implementations, at least a portion, and in some cases, all, of a module can be executed on the processor of a general purpose computer. Accordingly, each module can be realized in a variety of suitable configurations, and should not be limited to any example implementation exemplified herein.

According to an exemplary aspect, the audio synchronization engine 120 comprises a metadata analyzer 400, an audio analyzer 401 and a sequence generator 404. The audio analyzer 401 is configured to receive the video data 1 through N and the associated audio data 208 for each data set. The audio analyzer 401 then is configured to analyze the video data 1 through N along with the audio data 208 (associated with video data 1 through N) to identify clips that were shot at overlapping times. In exemplary aspects, the sequence generator 404 is configured to analyze the audio data and determine optimal synchronization points for the video data, such that the video data can be aligned with the audio data based on this synchronization point (e.g., the characteristic point discussed above), and a reference time for the video data. Those clips that are shot at overlapping times are clustered into various groups. The audio analyzer 401 is configured to invoke the metadata analyzer 400 to compare times specified in the metadata of the audio data 208 with the timecode data 202 for the video data 1-N and the camera identification data 206 to improve accuracy and correct the clustering of the clips into groups. Once the timecode and metadata is compared, the sequence generator 404 generates sequences 1 to M using the synchronization result from the audio analyzer 401.

In an exemplary aspect, if the metadata analyzer 400 determines that the scenes in the video data 1-N are inconsistent based on timecode or recording date and time, then multiple sequences are created. Video data with the same camera identification data are not analyzed together, but instead the video data that has different camera identification data or no camera identification data are analyzed together to be synchronized.

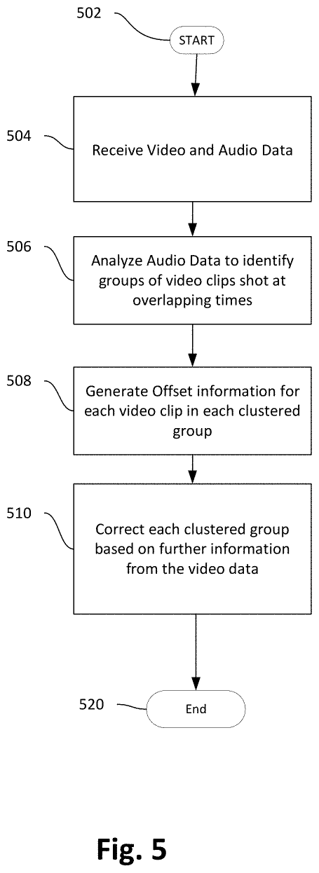

FIG. 5 is a flow diagram of a method of synchronizing video clips with audio data, in accordance with exemplary aspects of the present disclosure. It should be appreciated that the method can be implemented using the components of the systems as described above as would be appreciated to one skilled in the art.

The method 500 begins at 502, which can be, for example, the content of essence by the plurality of cameras 110-1 to 110-N (i.e., video capture devices). The method proceeds to 504, in which audio and video data is received by the audio synchronization engine 120 shown in FIG. 1. In exemplary aspects, the video data includes several components, as illustrated in FIG. 2 and the audio data includes several components illustrated in FIG. 3. Specifically, the video data includes time code data, and camera identification data, while the audio data includes metadata relating to the raw audio, including metadata related to the capture of the audio data. In some aspects the audio and video data is directly received from the respective capture device (e.g., microphone and video cameras), while in other aspects the data may be received or retrieved from a data store, e.g., data store 140. In some aspects, video data can be received simultaneously from live sources such as video cameras and from the data store.

At 506, the audio synchronization engine 120 analyzes the audio data to identify groups of video clips to identify groups of video clips shot at overlapping times. In exemplary aspects, audio analysis includes establishing a characteristic point in the related video clips by analyzing frequency spectrum or the like. Each of the groups comprise clips that have been captured at similar times during the day by one or more cameras. For example, if a first camera and a second camera were capturing a scene around 10:00 AM, but later these cameras were filming different scenes at different times, then the first set of clips are grouped into a single group, whereas the other clips are in one or more different groups that contain related video data.

The method then proceeds to 508, where the audio synchronization engine 120 generates offset information for each video clip in each clustered group. In other words, the offset represents the time duration that the video clip is offset from an identified characteristic point (e.g., a common audio point between the video clips in the group) in the audio data, thus anchoring the clips into a cluster or group, establishing that these are related video clips.

At 510, the audio synchronization engine 120 corrects each clustered group based on the time code data, camera identification data and the like in order to generate a plurality of video sequences with synchronized audio information. In exemplary aspects, the audio synchronization engine 120 uses camera identification data to determines whether video clips that are not overlapping have been clustered into the same group erroneously. In one aspect, it is noted that step 510 can be an option step that is not performed if the clustered groups are determined to be correct based on steps 502-508.

The method terminates at 520, which, for example, can end with the generation of synchronized media Sequences 1 through N as discussed above.

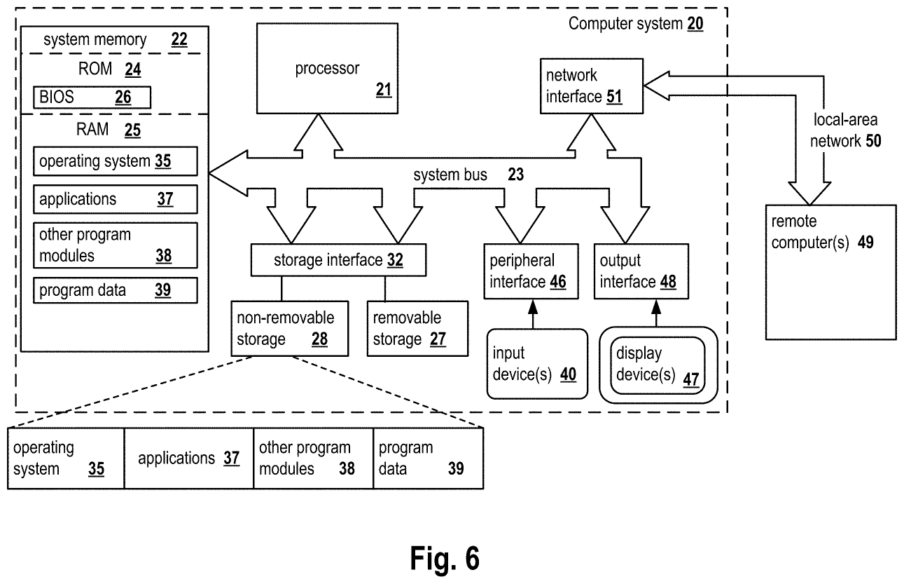

FIG. 6 is a block diagram illustrating a computer system 20 on which aspects of systems and methods of synchronizing video clips with audio data. It should be noted that the computer system 20 can correspond to the system 100 or any components therein. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable codes implementing the techniques of the present disclosure. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some aspects, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system (such as the one described in greater detail in FIG. 5, above). Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

What is claimed:

1. A system for synchronizing video clips with audio data, the system comprising:
a plurality of more video capture devices configured to capture audio and video data of a scene and to generate timecode data for the video data respectively;
a data store configured to store the audio and video data generated by each respective capture device and metadata that includes the generated timecode data and camera identification data;
an audio analyzer configured to analyze the audio data to determine a group of overlapping video clips in the video data based on a common characteristic point for the audio data associated with the group of overlapping video clips, and further configured to generate offset information for each video clip in the group that represents respective time durations that each video clip in the group of overlapping video clips is time offset from the characteristic point;
a metadata analyzer configured to correct the group of the overlapping video clips based on the generated timecode data and the camera identification data for the respective capture devices;
a sequence generator configured to generate a plurality of video sequences with synchronized audio for the group of the overlapping video clips, wherein the plurality of video sequences are generated as a video editing file configured for editing by a video software editing application.

2. The system according to claim 1, wherein the camera identification data comprises a reel name and serial information for each respective video capture device.

3. The system according to claim 1, wherein the audio analyzer is further configured to determine the group of overlapping video clips by comparing audio signals associated with the plurality of video capture devices to identify the common characteristic point.

4. The system according to claim 3, wherein the audio analyzer is further configured compare the audio signals based on a frequency spectrum analysis or volume comparison of the respective audio data captured by the plurality of video capture devices.

5. The system according to claim 1, wherein the group of overlapping video clips in the video data is a subset of the video data based on the time offset being within a predefined time duration of the characteristic point.

6. A system for synchronizing video clips with audio data, the system comprising:
at least one video capture device configured to capture video data of a scene and to generate timecode data for the video data;
a data store configured to store video data generated by each respective capture device, audio for the video data, and metadata that includes the generated timecode data;
an audio analyzer configured to analyze the audio data to determine a group of overlapping video clips in the video data based on a characteristic point for the audio data associated with the group of overlapping video clips, and further configured to generate offset information for each video clip in the group that represents respective time durations that each video clip in the group of overlapping video clips is time offset from the characteristic point;
a metadata analyzer configured to correct the group of the overlapping video clips based on the generated timecode data of the video data and the generated offset information for each video clip; and
a sequence generator configured to generate a plurality of video sequences with synchronized audio for the group of the overlapping video clips.

7. The system according to claim 6, wherein the plurality of video sequences are generated as part of a video editing file configured for editing by a video software editing application.

8. The system according to claim 6, wherein the data store is configured to store camera identification data for the at least one video capture device.

9. The system according to claim 7, wherein the metadata analyzer is configured to correct the group of the overlapping video clips based on the camera identification data for the at least one video capture device.

10. The system according to claim 9, wherein the camera identification data comprises a reel name and serial information for the at least one video capture device.

11. The system according to claim 6, wherein the audio analyzer is further configured to determine the group of overlapping video clips by comparing audio signals associated with the at least one video capture device to identify the characteristic point that is common to the respective video data.

12. The system according to claim 11, wherein the audio analyzer is further configured compare the audio signals based on a frequency spectrum analysis or volume comparison of the respective audio data captured by the at least one video capture device.

13. The system according to claim 6, wherein the group of overlapping video clips in the video data is a subset of the video data based on the time offset being within a predefined time duration of the characteristic point.

14. A system for synchronizing video clips with audio data, the system comprising:
a video capture device configured to capture video data of a scene and to generate timecode data for the video data;
an audio analyzer configured to analyze audio data associated with the video data to determine a group of overlapping video clips in the video data based on a characteristic point for the audio data associated with the group of overlapping video clips, and further configured to generate offset information for each video clip in the group;
a metadata analyzer configured to correct the group of the overlapping video clips based on the generated timecode data of the video data and the generated offset information for each video clip; and
a sequence generator configured to generate a plurality of video sequences with synchronized audio from the audio data for the group of the overlapping video clips, wherein the plurality of video sequences are generated as part of a video editing file configured for editing by a video software editing application.

15. The system according to claim 14, further comprising a data store configured to store the video data generated by the capture device, the audio data for the video data, and metadata that includes the generated timecode data.

16. The system according to claim 14, wherein the generated offset information for each video clip in the group represents respective time durations that each video clip in the group of overlapping video clips is time offset from the characteristic point.

17. The system according to claim 16, wherein the data store is configured to store camera identification data for the video capture device, and the metadata analyzer is configured to correct the group of the overlapping video clips based on the camera identification data for the video capture device.

18. The system according to claim 17, wherein the camera identification data comprises a reel name and serial information for the video capture device.

19. The system according to claim 14, wherein the audio analyzer is further configured to determine the group of overlapping video clips by comparing audio signals associated with the video capture device to identify the characteristic point that is common to the respective video data.

20. The system according to claim 19, wherein the audio analyzer is further configured compare the audio signals based on a frequency spectrum analysis or volume comparison of the respective audio data captured by the video capture device.

21. The system according to claim 15, wherein the group of overlapping video clips in the video data is a subset of the video data based on the time offset being within a predefined time duration of the characteristic point.
